(19) United States
(12) Patent Application Publication
(10) Pub. No.: US 2015/0359380 A1
(43) Pub. Date: Dec. 17, 2015

(54) COFFEE MAKER AND BREWING METHOD

(71) Applicant: John Oleksy, Sudbury, MA (US)

(72) Inventor: John Oleksy, Sudbury, MA (US)

(21) Appl. No.: 14/303,579

(22) Filed: Jun. 12, 2014

(51) Int. Cl. A47J 31/56; A47J 31/42; A23F 5/26; A47J 31/46

(52) U.S. Cl. CPC A47J 31/56; A47J 31/462; A47J 31/42; A23F 5/262

(57) ABSTRACT

An automatic coffee grind and brew device includes separate and independently controlled water heating elements for heating one or two servings sizes. The system maintains the water and coffee grounds in full contact at recommended brewing temperatures for the entire duration of the brewing cycle and uses real time water temperature feedback to operate the water heating elements in a manner that maintains the recommended brewing temperature during the entire duration of the brewing cycle. The system uses a full contact brewing method that closely matches a French press brewing method and also controls brew temperature during the full contact period. An agitator module generates water turbulence to improve extraction. A port valve assembly prevents coffee from exiting the brewing chamber until a desired brewing duration is reached.

### 1 BACKGROUND OF THE INVENTION

1.1 Field of the Invention

The exemplary illustrative technology herein relates to a coffee grind and brew system and its operating modes.

The technology herein has applications in the areas of brewing coffee, tea and other beverages that require heating water to a desired brew temperature and maintaining the water temperature during brewing.

1.2 The Related Art

Coffee brewing requires extracting flavor components from solid coffee beans to liquid water. In coffee brewing, roasted coffee beans are ground into particles or grounds and mixed with heated water for brewing. The coffee bean flavor components are extracted to the heated water during a contact period or brewing time during which the coffee grounds and the water are in contact. The Specialty Coffee Association of Europe defines coffee strength as the ratio of dissolved coffee solids to water in the finished beverage and suggests that the proper ratio is 1.20 to 1.45% coffee solids to water. To achieve the proper ratio of coffee solids to water, they suggest a coffee grounds to water ratio of 50 to 70 grams of ground coffee per liter of water. Additionally, they report that while up to 30% of coffee solids can be dissolved in the finished beverage, the best coffee flavor is provided when only 18-20% of coffee solids are dissolved or extracted.

The extraction process or coffee brewing is strongly influenced by the extraction temperature and by the contact or brewing time duration. However, when coffee beans are ground to different coffee grind coarseness levels, the desired contact time changes according to the coarseness with more coarsely ground coffee beans taking longer to dissolve coffee solids into water than more finely ground coffee beans. This is because finely ground beans have more surface area in contact with the water and the large surface area contact with the water speeds up the extraction. Thus, finely ground coffee beans require less contact time than more coarsely ground coffee beans to yield the same extractions results (e.g. 18-20% of dissolved solids).

In one example range of grind coarseness a coarse grind grinds a single roasted coffee bean into 100-300 particles, a filter or regular grind is 500-800 particles per roasted coffee bean, a filter fine grind is 1000-3000 particles per roasted coffee bean and an espresso grind is about 3500 particles per roasted coffee bean. Generally the brew or contact time starts when the water and the ground coffee make contact and ends when the coffee grounds and brewed coffee are separated. The Specialty Coffee Association of Europe suggests brew times of 1-4 minutes for filter fine ground coffee beans, 4-6 minutes for filter or regular ground coffee beans and 6-8 minutes for coarse ground coffee beans. The Specialty Coffee Association of Europe further suggests that the ideal brewing temperature for coffee extraction is 91 to 96° C. or 195 to 205° F. and that the coffee should remain at the ideal brewing temperature for at least 90% of the brew time. Additionally the Specialty Coffee Association of Europe further suggests that turbulence or the mixing action caused by water passing through and over the coffee grounds enhances coffee extraction by presenting more surface area for contact with the water. As for filtering, the Specialty Coffee Association of Europe recommends a permanent non-paper filter be used to strain coffee grounds from the brewed coffee.

While conventional automatic coffee makers heat and dispense hot water for brewing, conventional coffee makers fail to measure or control the water temperature during the entire brewing time as suggested by coffee brewing experts. Additionally while coffee is brewed by a variety of brewing methods, e.g. French press, percolation, decoction, filter drip, vacuum pot and pressure infusion, the majority of automated coffee makers employ a filter drip or percolation method, neither of which is considered to produce the best coffee flavor. Instead most coffee brewing experts agree that the French press method produces the best coffee flavor in part because when performed carefully the French press method substantially matches the recommended coffee brewing parameters described above. However even the French press method performed manually fails to measure or control the temperature of the water at the start of the brewing process and does nothing to prevent the water from cooling during the brewing time. While desirable coffee brewing parameters are known, most conventional automated coffee making devices fail to stringently attempt to consistently provide top quality coffee brewing. Thus there is a need in the art for an automated coffee maker that brews coffee while adhering to recommended coffee brewing parameters such as water temperature control, matching grind coarseness to brewing time, providing turbulence to enhance extraction and filtering with a non-paper filter. In particular there is a need in the art for an automated coffee maker that brews coffee using the French press brewing method and actually improves on the French press brewing method by maintaining the water at the recommended brewing temperature for the entire brew time.

### 2 SUMMARY OF THE INVENTION

The above listed problems with automated coffee brewing devices are addressed by the present invention by providing a simple grind and brew coffee system suitable for making one or two coffee servings with superior coffee flavor and consistency from one use to another. In particular the systems of the present invention are configured to follow the coffee brewing guidelines set forth above and recommended by the Specialty Coffee Association of Europe.

In particular the present invention is a coffee brewing device that includes a water receptacle having a liquid volume capacity of at least two coffee servings wherein the water receptacle has a least one fill level indicator showing a single coffee serving level.

Two independently operable electrical heating elements are attached to surfaces of the water receptacle for heating the water inside the water receptacle. A first electrical heating element is disposed proximate to a first portion of the water receptacle associated with heating water for a single coffee serving and a second electrical heating element is disposed proximate to a second portion of the water receptacle associated with heating water for more two or more coffee servings.

An electronic controller includes a power module configured to deliver a power signal to each of the first and second electrical heating elements through a switching module with independently operable switches for delivering power to or disconnecting power from one or both of the first and second electrical heating elements independently. A logic element and an associated memory module are provided to run a control program based on performing logical operations. The logic element independently communicates with each of the first and second switching elements an operates to selectively open or close one or the other or both of the switching elements in accordance with one or more operating modes of the control program. A user interface is provided to allow a user to make operating mode selections such as start or stop a coffee brewing cycle and other commands or selections.

A first thermal sensor in communication with the logic element is positioned proximate to the first electrical heating element and generates a first thermal sensor signal in response to a variation in thermal energy proximate to the first electrical heating element. A second thermal sensor in communication with the logic element is positioned proximate to the second electrical heating element and generates a second thermal sensor signal in response to a variation in thermal energy proximate to the second electrical heating element. The electronic controller operates to monitor the thermal sensor electrical signal from each of the first and second thermal sensors and to covert the thermal sensor electrical signals to actual temperature values based on sensor signal to temperature conversion data stored in the memory module. Alternately the conversion may be performed by the thermal sensors. In one example the thermal sensors are thermistors. The coffee module operates to heat water to a brewing temperature in the range of 91 to 96° C. and thereafter to maintain the water temperature within the brewing temperature range of 91 to 96° C. for at least 90% of a brew time. An expected heating profile of temperature vs heating time is stored in the memory module and the logic element operates to compare each thermal sensor electrical signal value with an expected heating profile and disconnects any heating element from the power module whenever the thermal sensor signal associated with a heating element deviates from the expected heating profile.

A grinding module is provided to grind coffee beans. A hopper for receiving whole coffee beans and grinding elements for grinding the coffee beans are disposed above the water receptacle. A rotary motor rotates one of the grinding elements to grind coffee beans and the coffee grinds exiting from the bean grinding module are gravity fed into the water receptacle during grinding. A rotatable serrated grinding element is rotated at 300 RPM but may be rotated up to about 600 RPM to reduce coffee bean heating and static electrical charge build-up due to bean grinding.

A port valve module includes a port valve element disposed to seal one or more dispensing ports passing through a bottom wall of the water receptacle. A is provided to apply a biasing force to bias the port valve element to a closed position which seals the dispensing ports. An electrical valve actuator coupled to the port valve element by a linkage is used to overcome the biasing force applied by the spring to move the port valve element to an open position to dispense coffee from the water receptacle through the dispensing ports. The electrical vale actuator is operated by the logic element and the power and switching module close the dispensing port when no power is applied or to open the dispensing port to dispense coffee therefrom when power is applied to the electrical valve actuator.

A rotatable agitator blade coupled to a rotary motor and is rotated to generate turbulence during a brewing cycle. The rotary motor is controlled by the logic element to turn the agitator blade either continuously or intermittently during a coffee brewing cycle. The rotary more may be the same motor that operates the serrated rotating coffee grinding element such that the coffee grinder and the agitator blade are always rotated together.

A coffee filter assembly including a filter element is installed inside the water receptacle. The filter element is disposed to filter the coffee grounds from the water inside the water receptacle as the water inside the water receptacle is dispensed through the dispensing port. The coffee filter assembly is removable from the water receptacle by a user for cleaning. The agitator blade is positioned between the base wall of the water receptacle and the coffee filter.

The present invention is a coffee brewing method that includes heating water in a water receptacle to a brewing temperature in a range of 91 to 96° C. and once the brewing temperature range is achieved starting rotation of the rotary motor to grind coffee beans and agitate the water as the coffee ground are dispensed into the water receptacle. Additionally the logic element starts a brew time clock to track coffee brewing time. The device is configured to maintain full contact between the water in the water receptacle and the coffee grounds for the entire brewing time which is usually about 3 minutes. During the brewing time the heating elements and thermal sensors are operated to maintain the temperature of the water in the water receptacle within the brewing temperature range for at least 90% of the desired brewing time. Once the brewing time duration has ended, the dispensing port is opened by operating the electrical valve actuator to move the port valve element from the sealing position so that coffee is dispensed through the dispensing port.

These and other aspects and advantages will become apparent when the Description below is read in conjunction with the accompanying Drawings.

### BRIEF DESCRIPTION OF THE DRAWINGS

The features of the present invention will best be understood from a detailed description of the invention and example embodiments thereof selected for the purposes of illustration and shown in the accompanying drawings in which:

FIG. 1 depicts an exemplary isometric view of a two cup coffee grind and brew system according to the present invention.

FIG. 2 depicts an exemplary section view taken through a central axis of selected elements for a coffee grind and brew system according to the present invention.

FIG. 3A depicts exemplary isometric view of water receptacle and heating modules for a coffee grind and brew system according to the present invention.

FIG. 3B depicts an exemplary section view taken through a water receptacle module for a coffee grind and brew system according to the present invention.

FIG. 3C depicts an exemplary top view of a water receptacle module for a coffee grind and brew system according to the present invention.

FIG. 4 depicts an exemplary section view taken through a heating module attached to an outside surface of a cylindrical wall of the water receptacle module according to one aspect of the present invention.

FIG. 5A depicts an exemplary isometric view of coffee filter assembly for a coffee grind and brew system according to the present invention.

FIG. 5B depicts an exemplary top view of a coffee filter assembly for a coffee grind and brew system according to the present invention.

FIG. 6A depicts an exemplary section view taken through a central longitudinal axis of the brewing module according to the present invention.

FIG. 6B depicts an exemplary top view of a stirring blade and magnetic coupling according to one aspect of the present invention.

FIG. 6C depicts an exemplary side view of a stirring blade module and associated rotary magnetic couplings according to one aspect of the present invention.

FIG. 7A depicts an exemplary side view of a port valve actuator module according to the present invention.

FIG. 7B depicts an exemplary bottom isometric view of a port valve actuator module according to the present invention.

FIG. 7C depicts detail A from FIG. 7B showing the port valve module in the closed position according to the present invention.

FIG. 7D depicts detail A from FIG. 7B showing the port valve module in the opened position according to the present invention.

FIG. 8A depicts an exemplary isometric view of lower and upper housing modules of a coffee grind and brew system according to the present invention.

FIG. 8B depicts an exemplary exploded isometric view of lower and upper housing modules of a coffee grind and brew system according to the present invention.

FIG. 9 depicts a block diagram showing elements of an exemplary electronic controller according to the present invention.

FIG. 10 depicts a block diagram showing steps of an exemplary operating mode according to the present invention.

Item Number List

The following item numbers are used throughout, unless specifically indicated otherwise.

| # | DESCRIPTION | # | DESCRIPTION |
|---|---|---|---|
| 20 | Base housing | 400 | Heating element |
| 22 | Cup | 402 | Water level |
| 24 | Cup | 404 | Backing material |
| 26 | Aperture | 406 | Heating wire |
| 28 | Hopper | 408 | Coils |
| 30 | Start button | 410 | Adhesive Layer |
| 32 | Indicator light | 412 | Insulating Layer |
| 34 | Filter handle | | |
| 100 | Coffee grind and brew design | 500 | Filter assembly |
| | | 502 | Annular ring |
| 200 | Coffee grind and brew device | 504 | Top aperture |
| 202 | Grinding module | 506 | Filter disk |
| 204 | Brewing module | 508 | Circular peripheral edge |
| 206 | Slopped side wall | 510 | Center brace |
| 208 | Upper aperture | 512 | Mesh filter portion |
| 210 | Cylindrical sidewall | 514 | Mesh filter portion |
| 212 | Axial bore | 516 | Filter rod |
| 214 | Base wall | 518 | Rod upper end |
| | | 520 | Rod lower end |
| 218 | Fixed serrated outer portion | 522 | Spherical knob |
| 220 | Rotating serrated inner portion | 524 | Center hole |
| 222 | Extension shaft | | |
| 224 | Annular grind area | 600 | Agitator module |
| 226 | Rotary shaft | 602 | Blade |
| 228 | Rotary motor module | 604 | Rotary drive coupling |
| 230 | Rotary drive coupling | 606 | 1st magnetic coupling element |
| 232 | Finger guard | 608 | 1^{st} magnetized disk portion |
| 234 | Rotary ball bearing | 610 | 2^{nd} magnetic coupling element |
| 236 | Annular spacer | 612 | 2^{nd} magnetized disk portion |
| 238 | Small diameter extension | 614 | 0-ring |
| 240 | Shoulder | | |
| 242 | Annular passage | 700 | Actuator module |
| 244 | Exit aperture | 705 | Port valve module |
| 246 | Reduction gear assembly | 715 | Piston |
| 248 | Rotary motor | 720 | Solenoid housing |
| 250 | Rotary Shaft | 725 | Mechanical linkage |
| | | 730 | Compression spring |
| 254 | Longitudinal drive axis | 740 | Spring tab |
| 256 | Electronic motor driver | 745 | Link pivot joint |
| 300 | Water receptacle | 750 | Plate pivot joint |
| 302 | Cylindrical wall | 755 | Contact pad |
| 304 | Base wall | 760 | Rim |
| 306 | Top circular aperture | 765 | Slotted aperture |
| 308 | 1^{st} Fill level | | |
| 310 | 2^{nd} Fill level | | |
| 312 | 1^{st} Heating element | 800 | Housing |
| 314 | 2^{nd} Heating element | 805 | Lower Housing |
| 316 | Electrical terminals | 810 | Upper housing |
| 318 | Dispensing port | 812 | Lower housing axis |
| 320 | Dispensing port | 814 | Water receptacle axis |
| 322 | Thermistor | 815 | Screws |
| 324 | Thermistor | 820 | Circular hole |
| | | 830 | Base wall |
| 1000 | Flow diagram | 835 | Cylindrical outer wall |
| 1005 | Single coffee cup placed | 840 | Mid-plate |
| | centered | | |
| 1010 | Whole coffee beans added | 845 | Top housing outer wall |
| 1015 | Install clean filter | 850 | Top plate |
| 1020 | Fill water receptacle | 860 | Fastener links |
| 1025 | Push start button | | |
| 1030 | Indicator light on | 900 | Electronic controller |
| 1035 | Heat water start | 905 | Circuit board |
| 1040 | Power rotary motor | 910 | Power module |
| 1045 | Turn off unused heater | 915 | On/Off switch |
| 1050 | Open port valve | 920 | DC power devices |
| 1055 | Close port valve | 925 | Wire or power bus |
| 1060 | Remove brewed coffee | 930 | Wire or power bus |
| 1065 | Remove and clean filter | 935 | Logic controller |
| | | 945 | Switch controller or switching |
| | | | module |
| | | 950 | Memory module |
| | | 955 | Optional analog device |
| | | 960 | Optional AC or DC power devices |

### 3.1 Exemplary System Architecture

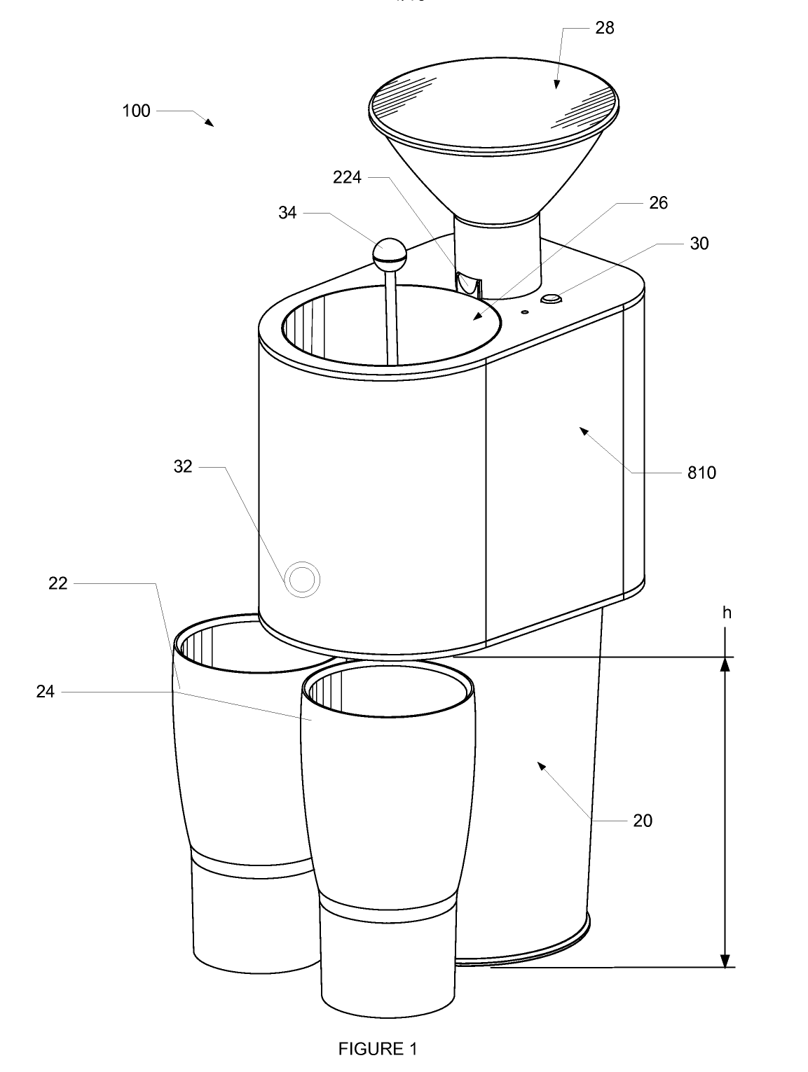

3.1.1 A non-limiting exemplary embodiment of the present invention is shown in isometric view in FIG. 1. As shown a free standing coffee bean grinding and brewing device (100) includes a base housing (20) for supporting the free standing device (100) on a counter top or other horizontal surface. The base housing (20) further supports a top housing (810) which is raised above the horizontal surface to a height (h) suitable for receiving a coffee cup under a front protruding edge of the top housing as will be detailed below. In the present example embodiment, two cups (22), (24) are positioned in a dispensing position under the front edge of the top housing (810). The cups rest directly on the horizontal counter top surface. In other operating modes only one cup (22) is placed in the dispensing position substantially centered between the depicted position of cups (22) and (24). In further embodiments the cups may be supported on a cup holding tray that extends out from the base housing.

In operation, a user adds a measured quantity of whole coffee beans into a hopper (28) and adds a measured quantity of fresh room temperature water into a water receptacle through an aperture (26). The user places either one or two cups (22, 24) in the dispensing position. When two cups are used the cups are placed side by side as shown. When a single cup is used the single cup is substantially centered with respect to the aperture (26). Once ready the user initiates a brewing cycle by pressing a start button (30) or similar toggle or user input device. While the brewing cycle is actively brewing an indicator light (32) or other user feedback element is lit. When the brewing cycle is complete the indicator light may be automatically turned off. In alternate embodiments, the indicator light my change colors, e.g. red during brewing, green when brewing is complete, and/or yellow to indicate a fault such as no coffee added, no water added, no cup in place, clean filter, or the like. In further alternate embodiments the indicator light may comprise a character or graphic elements display device, an audio speaker suitable for emitting audible warning sounds or computer generated verbal messages or the like, without deviating from the present invention. In a preferred operating mode, the weight of the measured quantity of coffee beans and the measured liquid water volume are in the ratio of 50 to 70 grams of coffee per liter of water. To provide the user with an easy measuring technique both the bean hopper (28) and the water receptacle (300) are marked with corresponding coffee bean and water fill levels for one and two coffee servings.

The coffee grind and brew device (100) preferably operates very simply using few or no digital logical elements. For example a user decides whether to brew one or two cups of coffee by placing one or two cups in the dispensing position and filling the coffee grinder and water receptacle with measured amounts of coffee beans and water according to whether the user wants to make one or two cups of coffee. Similarly the brewing cycle operates substantially the same for one or two cup brewing except that, as will be detailed below, only one heating element is used to brew a single cup and two heating elements are used to brew two cups.

After each brewing cycle is completed a user removes the coffee cups (22) and (24) or a single cup for consumption. To start another brewing cycle, the user removes a removable coffee filter assembly, detailed below, through the aperture (26) using a filter handle (34) and removes any used coffee grinds from the filter basket and rinses the filter element for reuse. The clean filter assembly is then reinstalled through the aperture (26), before adding water and coffee beans for another brewing cycle. The brewing device (100) includes a conventional AC power cord and power distribution module, (not shown), for use with a conventional home appliance power outlet.

### 3.1.2 Bean Grinding Module

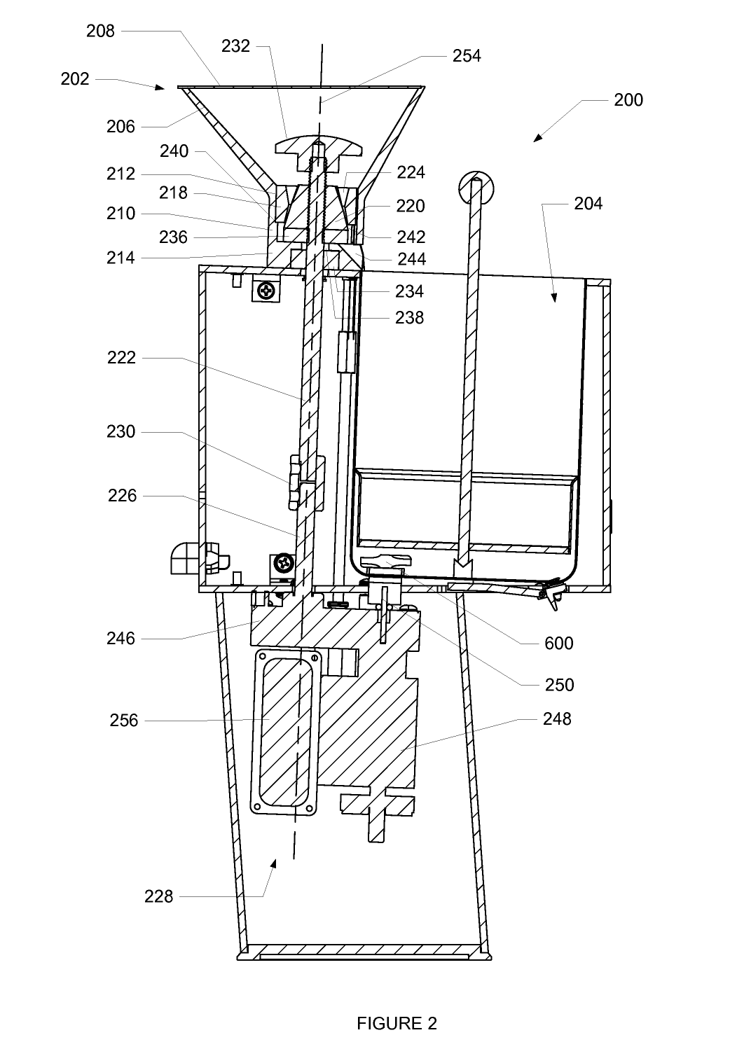

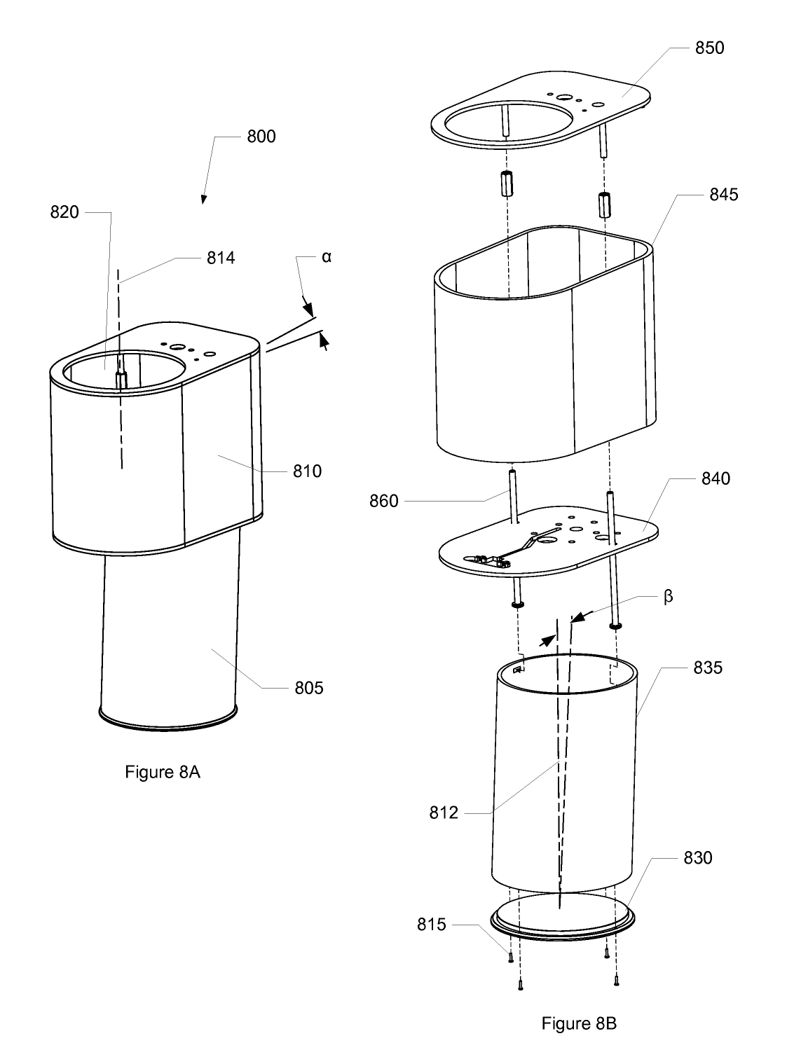

A non-limiting exemplary embodiment of the present invention is shown in FIG. 2 which depicts a side section view taken through a central axis of selected elements of the coffee grind and brew system (200) shown in FIG. 1. In particular the exemplary coffee bean grinding and brewing device (200) includes a coffee bean grinding module (202) and a brewing module (204). The grinding module (202) includes a hopper (26) for receiving whole coffee beans therein. The hopper is formed with a sloped annular side wall section (206) conically shaped to direct whole coffee bean to bean grinding elements. The sloped side wall (206) forms an upper aperture (208) for receiving whole coffee beans there through. The sloped side wall (206) mates with a cylindrical annular side wall section (210) which is preferably integrally formed with the sloped side wall (206). The cylindrical side wall (210) is open at an upper end thereof to receive coffee grinding elements into a cylindrical axial bore (212) formed at an apex of the sloped annular sidewall section (206). The cylindrical side wall (210) is closed at a lower end by a base wall (214). The base wall (212) rests on a top plate (850) of the upper housing (810), described below and shown in FIGS. 8A and 8B, and is secured in place by one or more fasteners, or the like.

In one non-limiting example embodiment the coffee bean grinding module (202) includes a conical burr grinder disposed within the axial bore (212) extending down to the base wall (214). The conical burr grinder is formed by a fixed serrated outer portion (218) and rotating serrated inner portion (220). The inner portion (220) is affixed to an extension shaft (222) and disposed to rotate with respect to the outer portion (218) to grind coffee beans funneled into an annular grind area (224) formed between the fixed serrated outer portion (218) and the rotating serrated inner portion (220) by the sloped side wall (206). In particular the grinder is configured to grind whole coffee beans to desired grind coarseness suitable for coffee brewing.

In the present non-limiting example embodiment, the conical burr grinder has a substantially fixed non-user-adjustable configuration suitable for consistently grinding whole coffee beans to uniform grind coarseness. In a preferred embodiment, the grinder module (202) is configured to provide a coarse grind such as may be used in a French Press. More specifically the coarse grind is coarser than would be generally recommended for making drip coffee and still coarser than would be recommended for espresso machines or the like. In the preferred embodiment grind coarseness is not user adjustable but preset by the manufacturer. In one example the coarse grind grinds a single roasted coffee bean into between 100 and 300 particles. By comparison a filter grind provides 500-800 particles per bean, a filter fine grind provides 1000-3000 particles per roasted coffee bean and an espresso grind provides 3500 particles per roasted coffee bean.

In other non-limiting embodiments the grinder may comprise various other coffee grinder types, e.g. a flat burr grinder, a blade grinder or a dosing grinder without deviating from the present invention. Similarly in other embodiments the grinder may be user adjustable with elements provided for a user to adjust the relative longitudinal position of one or both of the fixed serrated outer portion (218) and the rotating serrated inner portion (220) without deviating from the present invention.

The rotating serrated inner portion (220) is fixedly attached to a rotating extension shaft (222) for rotation therewith. The extension shaft (222) is rotationally coupled to a rotary motor module (228) which includes rotary shaft (226) that extends the rotary drive motor module (228). In the present non-limiting example embodiment a rotary drive coupling (230), or the like, fixedly attaches the extension shaft (222) to the rotary shaft (226).

A finger guard (232) is fixedly attached to the extension shaft (222) inside the conically sloped side wall section (206) and rotates with rotation of the extension shaft (222). The rotating finger guard further serves to guide unground coffee beans toward the annular grind area (224). Each of the rotating serrated inner portion (220) and the finger guard (232) includes a threaded axial bore to engage with a threaded upper end of the extension shaft (222). Other mechanical fastening elements are usable to attach the finger guard and grinder rotating serrated inner portion to extension shaft without deviating from the present invention.

The extension shaft upper end is supported for rotation with respect to the base wall (214) by a rotary ball bearing (234), or the like, which is installed in a blind bore provided in base wall (214) and held in place by a press fit, adhesive bond or other known capture or fastening technique. An annular spacer (236) is threaded onto the extension shaft (222) below the rotating serrated inner portion (220) and acts as a stop to define the longitudinal position the rotating serrated inner portion (220). The annular spacer (236) includes small diameter extension (238) disposed to contact an inner race of the ball bearing (234) such that a longitudinal length of the small diameter extension (238) is sized prevent the rotating serrated inner portion (220) from contacting the base wall (214) during rotation. In addition, the spacer (236) establishes the relative longitudinal position of the rotating serrated inner portion (220) with respect to the fixed serrated outer portion (218) which defines the grind coarseness of the coffee grinding. The longitudinal position of the fixed serrated outer portion (218) is defined by a shoulder (240) formed in the axial bore (212). In particular, the axial bore (212) is stepped in diameter with a larger upper diameter sized to receive the fixed serrated outer portion (218) therein with a press fit or adhesive bond. The axial bore (212) formed to the depth of the shoulder (240) defines the relative longitudinal position between the fixed serrated portion outer portion (218) and the rotating serrated inner portion (220).

A smaller lower diameter of the axial bore (212) defines an annular passage (242) surrounding the annular spacer (236). During operation of the grinder, ground coffee accumulates in the annular passage (242). An exit aperture (244) is formed by a notch cut in the base wall (214). The exit aperture (244) is positioned to deliver coffee grounds exiting from the annular passage (242) into the coffee brewing module (204) through its top open aperture described below. The annular spacer (236) is formed with one or more vanes, not shown, that extend from its outside diameter into the annular passage (242). Accordingly as the annular spacer (236) rotates with the shaft (222), the vanes extending into the annular passage (242) sweep coffee grounds accumulated in the annular passage from the annular passage and through the exit aperture (244) to be gravity fed into the coffee brewing module.

The rotary motor module (228) includes a reduction gear assembly (246) coupled to an electric powered rotary motor (248). The reduction gear assembly (246) reduces the rotational frequency and increases the torque output of the rotary shaft (226) as compared to the rotational frequency and torque output of the rotary motor (248). Accordingly the rotated serrated inner portion (220), and finger guard (232), is rotated at reduced rotational frequency and with increased torque as compared to the rotational frequency of the rotary motor (248). The gear reduction provided by the reduction gear assembly (246) is particularly beneficial since it lowers the rotational frequency of the rotating serrated portion (220). This improves bean grinding by substantially avoiding static charge buildup in the coffee grounds as well as by reducing thermal heating of the coffee grounds. The benefit of reducing static charge is that excessive static charge tends to clump coffee grounds together which tends to clog the exit aperture (244) and annular passage (242). Additionally clumping of coffee grounds is detrimental to coffee brewing since clumped coffee grounds have less surface area in contact with water during the brewing cycle and less surface contact between coffee grounds and water leads to incomplete coffee flavor extraction from the grounds. The benefit of reducing thermal heating of the coffee grounds is that excessive heating of the coffee grounds can lead to some of the desired coffee oils being vaporized or outgassed in the grinder thereby leaving less coffee oils available for brewing. Additionally, the benefit of increasing torque output to the extension shaft (222) is that the increased torque prevents grinder stalls or speed reductions which can also clog the grinder or lead to incomplete grinding.

In the present non-limiting example embodiment the rotary shaft (226) is rotated at 300 Revolutions Per Minute (RPM) as compared to the rotational frequency of the motor (248) which rotates at about 3400 RPM. Alternately, other motor speeds and grinder speeds are usable without deviating from the present invention. Alternately a direct drive configuration is usable to drive the grinder at the same rotational frequency as the rotary motor (248) without deviating from the present invention.

As further discussed below, the motor (248) includes rotary shaft (250) coupled to an agitator module (600), described below. The agitator module (600) is disposed at the base of the brewing module (204) and includes a rotary blade used to agitate water and coffee grounds during brewing. In the present non-limiting example embodiment the rotary motor (248) includes an output shaft (250) rotating at 3400 RPM coupled to the agitator module (600). Additionally the output shaft (250) rotating at 3400 RPM is coupled to the shaft (226) through the reduction gear module (246) which rotates the rotating serrated inner portion (220) at 300 RPM. The rotary motor module (228) also includes an electronic motor driver (256) in communication with an electronic controller described below. The motor driver starts and/or stops motor rotation under the control of electronic module.

As shown in FIG. 2, the extension shaft (222) and rotary shaft (226) are disposed along a longitudinal drive axis (254) which in the present example embodiment is a non-vertical axis. In particular the longitudinal drive axis (254) is disposed perpendicular to the top plate (850) which as is described below is tilted by about 2 degrees from horizontal to promote drainage of the brewing module (204).

### 3.1.3 Brewing Module

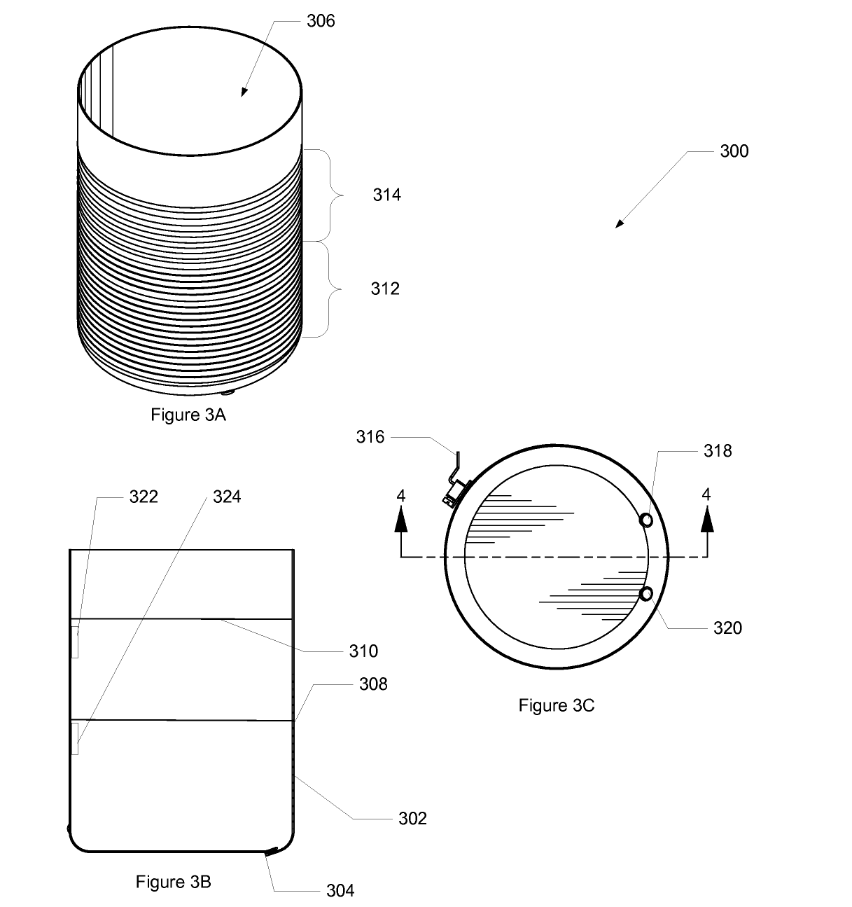

Referring now to FIGS. 2 and 3A through 3C, the brewing module (204) includes a cylindrical water receptacle (300) shown in three views in FIGS. 3A, 3B and 3C. The water receptacle (300) is an open topped container suitable for holding and heating water to a desired brewing temperature. In one non-limiting example embodiment the water receptacle (300) is a cylindrical cup shaped container formed by a thin cylindrical metal wall (302) and an integral thin disk shaped metal base wall (304) closing a lower rim of the cylindrical wall (302). A top circular aperture (306) is formed by an upper rim of the cylindrical wall (302) and the base wall (304) and cylindrical wall (302) are integrally formed from a single material blank such as by a deep draw metal stamping, hydroforming or other suitable metal forming process. In the present non-limiting example embodiment the water receptacle (300) is formed as a unitary element comprising 304 stainless steel having a substantially uniform side wall and base wall thickness of about 0.5 mm (0.02 inches), however the thickness can range from about 0.5 to 3.0 mm (0.02-0.12 inches). In particular 304 stainless steel is widely used for food and beverage containers. However other metals are usable for forming the water receptacle of the present invention without deviating from the present invention including but not limited to 316, 420, 430, stainless steels as well as copper, brass tin, aluminum or alloys thereof as long as such materials are manufactured to comply with food and beverage container standards. Alternately other thermally conductive corrosion resistant wall materials having a similar or different wall thickness are suitable without deviation from the present invention. In the present exemplary embodiment the water receptacle (300) is fixedly attached to structural housing elements, described below, and is not removable by a user. In other non-limiting example embodiments the water receptacle (300) may be removable from the brewing module by a user for cleaning. The water receptacle (300) is sized to brew at least two coffee servings, wherein each coffee serving ranges between 6 and 12 fluid ounces. Accordingly the preferred water receptacle holds a liquid volume between 12 and 24 fluid ounces. In other embodiments the water receptacle (300) may be sized to brew more than two coffee servings, e.g. up to about 80 fluid ounces, without deviating from the present invention. The water receptacle (300) includes fill level indicators (308) and (310) marked or otherwise formed on an inside surface (302) to indicate different fill levels e.g. corresponding with one serving, two servings or more than two servings. In operation a user fills the water receptacle with unheated water up to a fill level corresponding with a desired serving size, e.g. to fill line (308) for a single serving i.e. one cup under the dispensing ports, and to fill line (310) for two servings, i.e. two cups under the dispensing ports, and to a third fill line, not shown, for another larger serving size, e.g. a carafe placed under the dispensing ports.

The water receptacle (300) is formed with at least one and preferably two independently operable electric resistive heating elements (312) and (314) disposed around an outside surface of the cylindrical wall (302). Each heater element is separately controlled with a first electric heater (312) in thermal conductive contact with a lower outside surface of the cylindrical wall (302), for heating water for a single serving, and a second electric heater (314) in contact with an upper outside surface of the cylindrical wall (302) for heating water for two or more servings when the water receptacle is filled to a water level that extends above the level of the first heater (312).

A pair to temperature sensing elements (322) and (324) is positioned inside the water receptacle (300) such as bonded to the inside of wall (302) one below and one above the first water level mark (308) to determine water temperature, or if no water is present a temperature of the wall (302). Alternately the temperature sensing elements (322) and (324) can be installed on the outside of wall (302). In a preferred embodiment each sensor is in electrical communication with the electronic controller and provides an electrical signal that can be converted to provide an accurate water temperature measurement. In particular a desirable temperature sensing element provides temperature measurement in the range of 91 to 96° C. with a high resolution e.g. +/−about 0.2 to 0.6° C. and relatively short response time to changes in temperature, e.g. in the 3 to 5 second range. Preferably the temperature sensors (322) and (324) are thermistors but resistance temperature detectors or thermocouples are usable without deviating from the invention. Additionally an optical infrared thermometer module disposed to focus infrared radiation being emitted by water in the water recital onto a thermal sensor and to communicate a thermal sensor electrical signal to the logic element to determine water temperature is also usable without deviating from the present invention. Additionally, as further described below each thermal sensor is preferably calibrated to match its electrical signal response to actual water temperature vs time over a heating cycle. This is achieved by heating water in the water receptacle and recording actual water temperature, using a calibrated thermometer, and the corresponding thermal sensor electrical response signals at selected time periods during a water heating cycle. The recorded data provides a calibration or expected heating response profile curve which is stored in memory and is used to convert thermal sensor electrical response signals to actual water temperature values.

In a preferred embodiment wherein the water receptacle is sized for two servings, the first electric heater (312) is in thermal contact with a lower outside surface of the cylindrical wall (302) substantially up to the first fill level (308) which corresponds with a single coffee serving, and the second electric heater (314) is in thermal contact with an upper outside surface of the cylindrical wall (302) between the first fill level (308) and the second fill level (310) which corresponds with two coffee servings. Each heating element (312) and (314) includes a pair of electrical terminals (316) e.g. positive and negative electrical connectors provided to connect the heating element to a current source.

Referring to FIG. 3C, dispensing ports (318) and (320) comprising through holes passing through the base wall (304) are provided to dispense brewed coffee from the water receptacle. The dispensing ports (318) and (320) are positioned at a front edge of the water receptacle (300) which places the two dispensing ports one above each cup (22) and (24) shown in FIG. 1. The dispensing ports are provided to dispense brewed coffee from the water receptacle (300) to either one or two coffee cups placed in a dispensing position shown in FIG. 1 or to a single carafe that holds more than one serving or more than two servings depending on the fluid capacity of the water receptacle. Specifically the dispensing ports (318) and (320) are not centered over each cup (22) and (24) but instead the dispensing ports are separated by about 1.5 to 3 inches (38-76 mm) such that both dispensing ports (318) and (320) are positioned to dispense into a single cup or carafe placed in a centered dispensing position. However when two cups are placed side by side as shown in FIG. 1 the left dispensing port (318) is positioned to dispense into a first cup, e.g. (22) and the right dispensing port (320) is dispensed into a second cup, e.g. (24).

### 3.1.4 Example Heating Element Embodiment

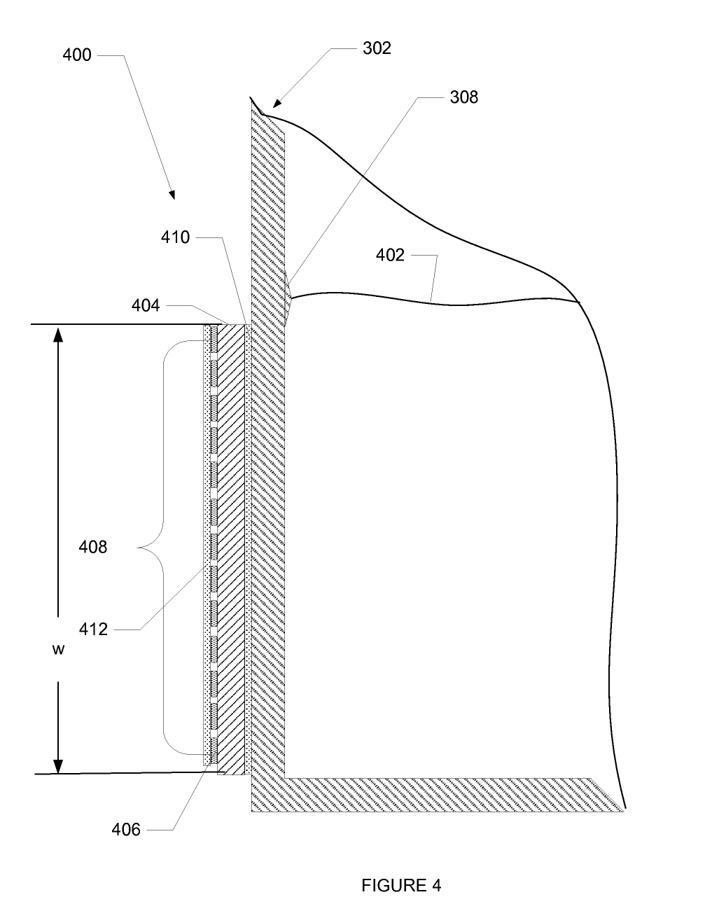

Referring now to FIG. 4, an exemplary heating element (400) according to one aspect of the present invention is shown in a partial section view mounted to a lower portion of the water receptacle (300) on the outside surface of the cylindrical wall (302). In the present example embodiment the water receptacle (300) is filled to a water level (402) which corresponds with the position of the first fill level indicator (308) associated with single serving brewing.

The heating element (400) comprises a thermally conductive backing material (404) comprising a sheet of thermally conductive electrically insulating flexible material such as ceramic filled silicone. The heating element (400) comprises a rectangular sheet having a width dimension (w) and a length dimension. The length dimension is sufficient to wrap approximately around a circumference of the cylindrical wall (302) and the width dimension (w) approximately matches the distance between the base wall (304) and the first fill level indicator (308). The backing material thickness is preferably about 0.020 to 0.050 inches (0.5-1.3 mm) which is substantially equal to the thickness of the stainless steel cylindrical wall (302). In a preferred embodiment the thermal conductivity of the backing material is approximately 3.0 W/m ° K, (Watts per meter per degree Kelvin) and the electrical resistivity of the backing material is greater than 10¹² Ω/sq (ohms per square)

In various embodiments each heating element (312) and (314) shown in FIG. 3A, may be fixedly attached to the water receptacle by adhesively bonding the backing material to the outside surface of the cylindrical wall. Alternately each heating element may include one or more clamping or fastening elements attached to each end of the longitudinal length of the backing material such that when the clamping or fastening elements interconnect they apply circumferentially directed mechanical tension suitable for pulling the backing material snug around the outside surface of the cylindrical wall and securing the backing material in place. Alternately each heating element may be held in place by one or more circumferential bands, not shown, placed over the heating element and cylindrical container and tightened by reducing their circumferential length until each band applies a radially inwardly directed mechanical clamping force securing the backing material in place.

Heating wire (406) attaches to the backing material (404) opposed to the outside surface of the cylindrical wall (302). In one example embodiment each heating wire (406) is a separate element having a longitudinal length approximately matched to the length dimension of the backing material (404). In this example embodiment each separate heating wire has two free ends with a first free end connected to a first conductive bus or terminal and a second free end connected to a second conductive bus or terminal. Thus each wire (406) has two free ends with one free end connected to a positive electrical input terminal and the other free end connected to a negative electrical input terminal and the electrical terminals are connected to corresponding positive and negative terminals of a current source. The number of separate heating elements is enough to substantially cover the backing material along its width dimension (w). In a preferred embodiment the wire (406) comprises a nickel chromium alloy rectangular wire having dimensions of 0.125 wide (2.18 mm) by 0.0031 (0.8 mm) thick. The wire may be adhesively bonded to the backing layer or laminated as described below.

In another example embodiment the heating element (400) comprises a single strand of wire wrapped around the backing material (404) opposed to the outside surface of the cylindrical wall (302). Specifically the single strand forms a coil (408) having a plurality of turns wrapped around the backing material and having two free ends. In this embodiment a first free end of the coil (408) is attached to a positive electrical input terminal and a second free end of the coil is attached to a negative electrical input terminal wherein each terminal corresponds with a positive and a negative terminal of a current source.

In a further example embodiment the heating element (400) comprises a plurality of lamination layers formed in sheet or web form and then cut to lengths and widths suitable for wrapping around the cylindrical wall. In one example the thermally conductive electrically insulating layer (404) comprises one or more material layers e.g. a center layer comprising a thermally conductive material covered on each opposing face by an electrically insulating layer or just on the face in contact with the wires (406) or (408). An adhesive layer, e.g. (410) may be applied to the backing material (404) for adhering to the cylindrical wall. Additionally the adhesive layer (410) may be covered by a peel away cover layer, not shown, which is removed to expose the adhesive layer (410) for bonding to the cylindrical wall. Another electrically insulating layer (412) may be applied over the wires (406) or (408) to prevent electrical shock and protect the wires from exposure to moisture.

### 3.1.4.1 Filter Assembly

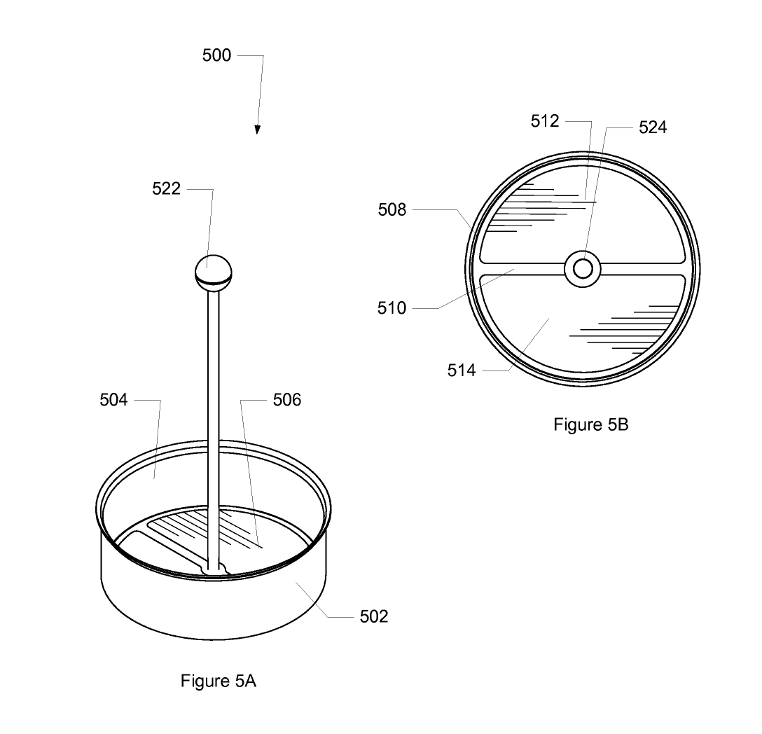

Referring now to FIGS. 2 and 5A-5B, the brewing module further includes a filter assembly (500). The filter assembly (500) installs into the water receptacle (300) and functions to filter coffee grounds from brewed coffee being dispensed through the dispensing ports (318) and (320).

The filter assembly (500) includes an annular ring (502) preferably formed from 22 gauge 303 stainless steel, or the like. The annular ring (502) forms an open top aperture (504) at a top rim thereof and a filter disk (506) attaches to a bottom rim of the annular ring (502) such as by any one of welding or soldering, by a mechanical interference fit with the annular ring, by adhesive bonding or other suitable mechanical fastening and or clamping techniques. The filter disk (506) includes one or more solid structural portions attached to the annular ring for supporting one or more mesh filter portions attached to the solid structural portions. In particular the filter disk (506) extends over an entire lower aperture formed by the bottom rim of the annular ring (502) and functions to trap coffee grounds within the annular ring while allowing brewed liquid coffee to penetrate through the mesh filter portions (512) and (514).

As shown in FIG. 5B, the filter disk (506) comprises a solid circular peripheral edge (508) attached to the bottom rim of the annular ring (502), a solid center brace (510) spanning at least one diametrical axis of the circular peripheral edge (508) and two mesh filter portions (512) and (514) attached to or integrally formed with the solid center brace (510) and the circular peripheral edge (508). In the present exemplary embodiment, the solid structural portions (508) and (510) are formed from 0.125 in. thick 304 stainless steel and the two mesh filter portions (512) and (514) extending between the circular peripheral edge (508) and the center brace (510) are formed from 304 stainless steel wire mesh e.g. 0.0037 inch (0.09 mm) diameter wire interwoven on a center to center pitch of about 0.0046 inches, (0.12 mm). However, other mesh sizes, weaves and other mesh materials, e.g. gold, silver, copper and non-metallic mesh materials can be used without deviating from the present invention.

In one example embodiment the circular peripheral edge (508) and the solid center brace (510) comprise a unitary solid support element having a circular diameter sized to interface with the outside diameter of the bottom rim of the annular ring (502). Similarly the two mesh filter portions (512) and (514) comprise a single unitary circular element made up of wire mesh. The diameter of the circular mesh element is substantially matched to the diameter of the unitary solid support element. The circular wire mesh element is assembled with and attached to the unitary solid support element and the assembled circular mesh element and solid support element are fixedly attached to the bottom rim of the annular ring (502). In another example embodiment the unitary solid support element comprises two substantially identical unitary solid support elements sandwiched together with the circular mesh portion held between the two substantially identical unitary solid support elements. These are then fixedly attached to each other e.g. by spot welds or mechanical fasteners or clamping features and then fixedly attached to the bottom rim of the annular ring (502).

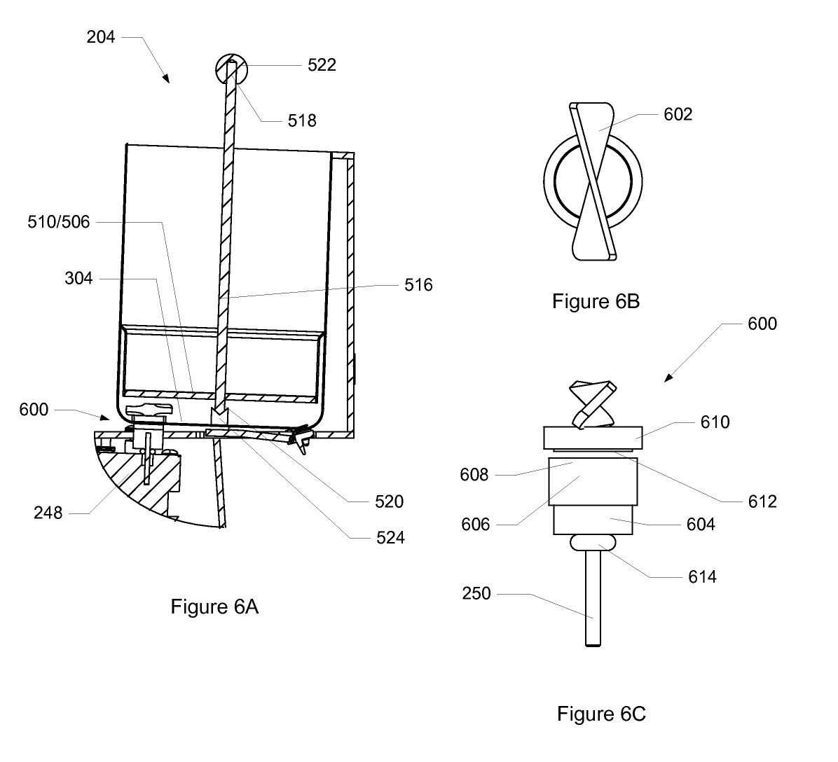

Referring to FIGS. 5A and 6A, a filter rod (516) is attached to the center brace (510). The filter rod (516) comprises a 304 stainless steel rod with a 0.19 inch (4.8 mm) diameter having an upper end (518) and a lower end (520). A plastic spherical knob (522) is attached to the upper end (518) and serves as a user handle for grasping and removing the filter assembly (500) from the water receptacle (300) for cleaning. Preferably the knob (520) comprises a thermally insulating material which substantially remains at room temperature during a brewing cycle.

In the present example embodiment the lower end (520) passes through a center hole (524) that passes through the solid center brace (510). The lower end (520) extends below the solid center brace (510) by a fixed dimension by fixedly capturing the filter rod (516) in the center hole (524). The rod may be captured using a snap ring or other mechanical stop feature such as a shoulder formed by reducing the rod diameter below the solid center brace. Alternately the rod (516) is fixedly attached to the solid center brace (510) by an adhesive bond. In any case the lower end (520) extends below the solid center brace (510) by a fixed dimension established to suspend the filter assembly above the agitating module (600) as well as to suspend the filter assembly above the dispensing ports. As is further shown in FIG. 6A a centering guide (526) is fixedly attached to the water receptacle base wall (304) and formed to guide the rod lower end (520) and the entire filter assembly to a centered position with respect to the water receptacle. Additionally the rod lower end (520) and the centering guide may be conically shaped to guide the rod end to a center position when the filter assembly is installed onto the water receptacle.

### 3.1.4.2 Agitator Module

Referring now to FIGS. 6A-6C the brewing module further includes an agitator module (600). The agitator module (600) includes a rotatable blade (602) disposed inside the water receptacle (300) below the filter disk (506). The agitator module (600) rotates the rotatable blade (602) whenever the rotary motor (248) is operating. Rotation of the blade (602) agitates water in the water receptacle (300) during the entire time that coffee beans are being ground by the grinding module (202) since the blade (602) and the coffee grinding element (220) are both rotated by the rotary motor (248). During the brewing cycle, after the coffee beans have been completely ground, the agitator blade (602) may be rotated continuously or rotated intermittently. The blade (602) is directly rotated by the rotary motor shaft (250) at 3400 RPM. The blade rotation keeps coffee grounds suspended in the water during the entire brewing cycle, even when the rotation is intermittent.

The agitator module (600) includes a rotary drive coupling (604) fixedly attached to the drive shaft (250). The drive shaft (250) extends from the rotary motor (248), described above, and rotates at the rotary frequency of the motor (248) which in the present example is 3400 RPM. The drive shaft (250) optionally includes a shaft extension, or the like, to extend the length of the motor shaft as required for coupling with the agitator module. In the present non-limiting example embodiment, the drive shaft (250) is fixedly attached to a first magnetic coupling element (606) which rotates with the shaft (250). The first magnetic coupling element (606) includes a first magnetized disk portion (608) disposed outside the water receptacle (300), proximate to a bottom surface of the water receptacle base wall (304). A second magnetic coupling element (610) is fixedly attached to the rotatable blade (602). The assembled magnetic coupling (610) and rotatable blade (602) is disposed inside the water receptacle between the filter disk (506) and the water receptacle base wall (304). The second magnetic coupling element (610) includes a second magnetized disk portion (612) disposed proximate to the water receptacle base wall (304) opposed to first magnetized disk portion (608) such that the first and second magnetized disk portions (608) and (612) are magnetically coupled through the base wall (304). Accordingly when the rotary motor (248) is not operating, the assembled magnetic coupling (610) and rotatable blade (602) are held in a stationary position inside the water receptacle by the magnetic coupling force, and when the rotary motor (248) is operating the assembled magnetic coupling (610) and rotatable blade (602) are rotated by the magnetic coupling force. As further shown in FIGS. 6A and 6B, a silicone or rubber O-ring (614), or the like, may be installed onto the shaft (250) proximate to the drive motor (248) to prevent contaminants from entering the motor (248) through the shaft interface.

An important aspect of the present invention is that the coffee grounds remain in full contact with the water inside the brewing basket during the entire coffee brew time. This is accomplished first by preventing liquid from exiting the water receptacle (300) before coffee brewing is completed, as will be described further below. Secondly the agitator module (600) generates fluid turbulence in the water during the brewing cycle which promotes full contact between coffee grounds and the water in the water receptacle by keeping the coffee grounds in suspension in the water during the entire coffee brew time. In particular applicants have demonstrated that even intermittent rotation of the blade (602) substantially promotes full contact since coffee grounds remain in suspension in the water due to currents/turbulence established by blade rotation and the currents/turbulence continue to keep the coffee grounds suspended in the water for at least 30 seconds after the blade stops rotating.

Full contact brewing has been shown to dissolve or extract more coffee ground solids than conventional drip and press systems. Accordingly full contact brewing improves coffee flavor. Thus the present invention improves over conventional coffee brewing systems by providing full contact brewing during the entire brew time which is not the case for drip and press coffee making systems which pass water through stationary and compacted coffee grounds settled on the bottom of a brew basket.

### 3.1.5 Dispensing Port Actuator Module

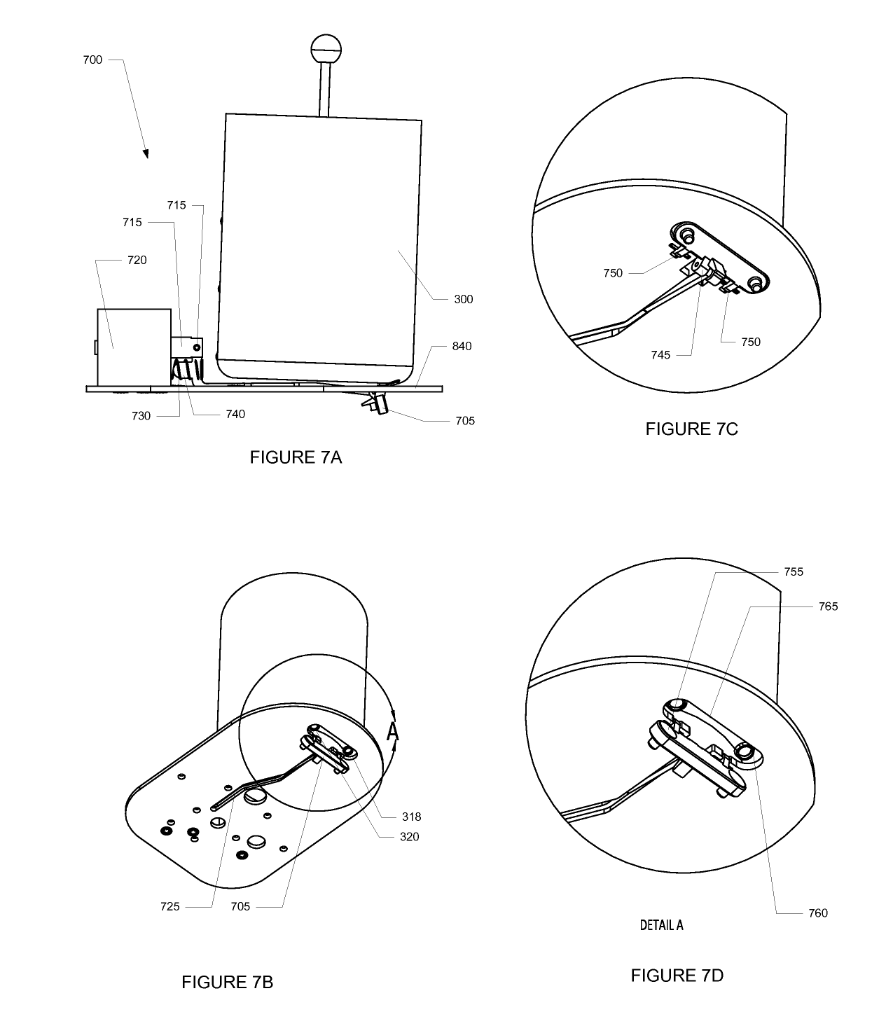

Referring now to FIGS. 7A through 7D and 8B the coffee brewing module (204) includes an actuator module (700) attached to a mid-plate (840). The actuator module includes a port valve module (705) operable to close and seal both of the two coffee dispending ports (318) and (320) that pass through the water receptacle base wall (304). The port valve module (705) is shown in a closed position in FIG. 7C and in an opened position in FIG. 7D. Generally the port valve module (705) is closed in order to seal the two dispensing ports to prevent water inside the water receptacle (300) from leaking out through the two port valves. The only time the port valve element (705) is opened is at the end of a coffee brewing cycle when the port valve module (705) is pivoted to an open position which allows all of the brewed coffee inside the water receptacle (300) to be dispensed out of the water receptacle through the two dispensing ports. After all of the brewed coffee has been dispensed out of the water receptacle the port valve module is closed to seal both dispensing ports.

The actuator module (700) includes a linear solenoid (710) attached to a top surface of the mid-plate (840) by mechanical fasteners. The linear solenoid (710) receives a power signal from an electronic controller, described below, which actuates the linear solenoid. In response to receiving the power signal, the linear solenoid (710) causes a piston (715) to be linearly drawn into a solenoid housing (720). The distance the piston moves is a stroke length.

A substantially ridged mechanical linkage (725) is disposed between the piston (710) and the port valve module (705). The linkage (725) is pivotally attached to an exposed end of the piston (715) at a pivot or attaching point (735) provided on a first end of the linkage (725). A compression spring (730) is disposed between the solenoid housing (720) and the mechanical linkage at the attaching point and the compression spring may be supported on a spring tab (740) provided at the first end of the linkage. The mechanical linkage (725) passes through the mid-plate (840) and a second end of the linkage is pivotally attached to the port valve module (705) at a link pivot joint (745). In addition, the port valve module (705) is pivotally attached to the mid-plate (840) at a plate pivot joint (750). Thus the linkage (725) is pivotally supported at its first end at the attaching point (735) and pivotally supported at its second end by the link pivot joint (745) and is otherwise free to move with respect to the mid-plate (840).

When the electronic controller actuates the linear solenoid (710) the piston (715) is drawn into the housing by a stroke length and both the first and second ends of the mechanical linkage (725) are drawn toward the solenoid housing (720) by the same stroke length. As a result of the position shift of the free end of the piston the compression spring (730) is compressed by a stroke length. The spring compression generates a restoring force that tends to restore the mechanical link to the original unactuated position. However the actuated solenoid (710) is able to overcome the spring restoring force as long as actuator power is applied by the electronic controller.

In response to the movement of the first end of the mechanical linkage the second end of the mechanical linkage moves toward the solenoid housing by a stroke length and causes the port valve module to pivot with respect to the mid-plate (840) moving the port valve module (705) from the closed position shown in FIG. 7C to the open position shown in FIG. 7D. With the port valve module (705) pivoted to the open position brewed coffee is dispensed from the water receptacle through the two dispensing ports. The port valve module remains in the open position for as long as actuator power is applied to the solenoid by the electronic controller. However as soon as the electronic controller terminates the actuator power signal to the linear solenoid (710) the restoring force applied by the compression spring (730) advances the piston (715) out of the housing (720) which restores the original position of the mechanical link (725) and the movement of the mechanical link (725) pivots the port valve assembly (705) to the closed position thereby stopping any liquid from flowing out of the water receptacle through the dispensing ports. Thus according to one aspect of the present invention any loss of power to the brew grind coffee maker results in the port valve module (705) being pivoted to the closed position by the compression spring (730). Moreover the compression spring (730) keeps the port valve assembly closed whenever a power signal is absent from the linear solenoid which is the case when the system in brew grind coffee maker is first turned on. Otherwise as will be further described below the electronic controller operates to close the port valve assembly by terminating the solenoid power actuator signal after sufficient time has elapsed to empty the water receptacle of brewed coffee.

Referring to FIG. 7D the port valve module (705) pivots through the mid-plate (840) to engage with the dispensing ports (318) and (320). Thus the mid-plate (840) includes a slotted aperture (765) positioned to provide a passage for the port valve module to pivot through the mid-plate and into contact with the water receptacle base wall (304) at a position consistent with contacting the base wall surrounding the dispensing ports (318) and (320). The mid-plate and the port valve module each includes mechanical features suitable for pivotally attaching the port valve module to a bottom surface of the mid-plate (840) in a manner that allows the port valve module to pivot through the mid-plate and into contact with the water receptacle base wall (304) at a position consistent with contacting the base wall surrounding the dispensing ports (318) and (320). The port valve assembly includes two contact pads (755) with one contact pad positioned to contact the dispensing port (318) and the other positioned to contact the dispensing port (320). The contact pads preferably comprise a pliable rubber or silicone cushion able to conform to the shape or orientation of the water receptacle base wall to improve liquid sealing. In addition each dispensing port (318) and (320) may be formed with a raised annular rim (760) protruding from a bottom surface of the water receptacle base wall (304) and surrounding each dispensing port to improve sealing. In one example embodiment the rim (760) may comprise a pliable gasket held in place by a suitable adhesive, for example silicone.

### 3.1.6 Housing and Structural Support

Referring now to FIGS. 8A and 8B and the section view of FIG. 2, an assembled grind and brew coffee maker housing (800) is shown in FIG. 8A and is further shown in exploded view in FIG. 8B. The housing (800) includes a cylindrical lower housing (805) and an upper housing (810). A mid-plate (840) is disposed between the lower housing (805) and the upper housing (810). A top plate (850) encloses a top portion of a top housing outer wall (845).

The lower housing encloses the rotatory drive motor assembly (228) which is suspended from the mid-plate (840) with the extension shaft (226) passing through the mid-plate and the top plate (850) to interface with the grinder module (202). Additionally the agitator module (600) passes through the mid-plate (840) to interface with the water receptacle (300). As described above the port valve module (705) is suspended from the mid-plate (840) to interface with the dispensing ports (318) and (320) passing through the water receptacle base wall (304).

The upper housing (810) encloses the water receptacle (300) and the agitator module (600). A circular hole (820) passing through the top plate (850) provides an opening for the filter assembly (500) to be installed into and removed from the water receptacle (300). An electronics assembly, only shown schematically, includes various electronic components mounted on an electronics board or the like which is housed inside the upper housing (810) fixedly attached to one of its inside walls.

Referring now to FIG. 8B the lower housing includes a cylindrical outer wall (835) and a circular base wall (830) fastened to the cylindrical outer wall by screws (815). The mid-plate (840) rests on top of the cylindrical outer wall (835). The upper housing is formed by a unitary upper outer wall (845) shaped to interface with the mid-plate (840). The upper outer wall (845) is open at top and bottom. The top plate (850) is shaped to interface with the upper outer wall (845) to enclose the upper housing (810). Fastener links (860) attach to the cylindrical outer wall (835), pass through the mid-plate (840), attach to the upper outer wall (845) and attach to the top wall (850). The fastener links (860) are snugged through the top wall (850) to secure the housing elements together as shown in FIG. 8A.

In a preferred embodiment the outer housing elements (835) and (845) comprise aluminum and the mid-plate (840) and the top plate (850) comprise 304 stainless steel while the base plate (830) is a suitable plastic. Additionally each of the housing elements (835) and (845) are configured for being fabricated from an extrusion. Alternately the housings and plates may comprise other metals such as aluminum, copper or brass or may comprise suitable plastic materials.

According to a further aspect of the invention the base wall (830) and the mid-plate (840) and are substantially parallel and disposed substantially horizontally when the coffee brew and grind module is placed on a horizontal surface. However the top plate (850) is tilted from horizontal to tilt the water receptacle downward in the front above the slotted aperture (765). As shown in FIG. 2, a top rim of the water receptacle (300) fits into the circular hole (820) which passes through the upper plate (850). Accordingly the water receptacle is supported by the upper plate. The top rim of the water receptacle attaches to the mating circular aperture (820) by welding, interference fit, adhesive bonding or other mechanical fasters. By tilting the upper plate downward in the front by an angle (α) with the front edge of the upper plate (850) closer to the mid-plate (840) than the back edge of the upper plate the water receptacle is also tilted downward such that the two dispensing ports (318) and (320) are positioned near the lowest point of the water receptacle to promote substantially complete drainage of the water receptacle through the dispensing ports. In one non-limiting example embodiment the angle (α) is between 1 and 15 degrees from horizontal and preferably about 2 degrees.

As shown in FIG. 8B a center longitudinal axis (812) of the lower housing outer wall is tilted back away from the front edge of the mid-plate by an angle (β). Preferably the angle (β) is twice the angle (α). A central longitudinal axis (814) of the water receptacle (300) is tilted from vertical by the angle (α) which is oriented at an angle (α) plus (β) from as measured from the longitudinal axis (812).

### 3.1.7 Electronics Controller

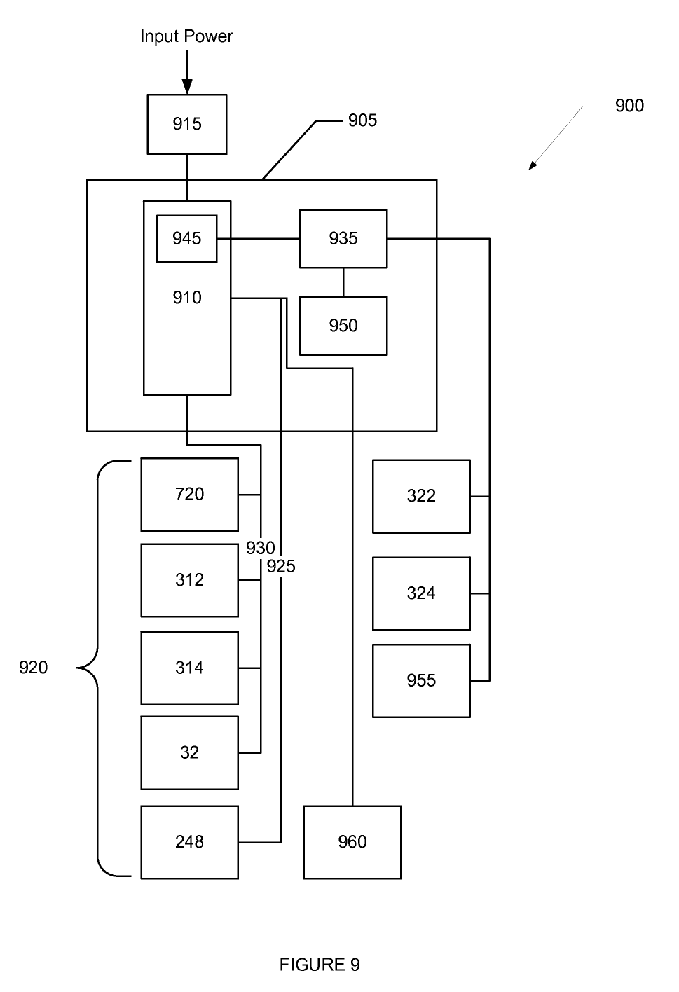

Referring now to FIG. 9 an electronic control module (900) is shown schematically. The electronic control module includes electronic elements and sub modules suitable for operating the grind and brew coffee maker described above. The control module includes a circuit board or the like (905) comprising one or more electronic elements mounted on the circuit board and electrically interconnected. In one non-limiting example embodiment the circuit board mechanically supports the electronic components which are electrically interconnected by wires or jumpers. In another non-limiting example embodiment the circuit board includes conductive pathways over which electrical circuit components are electrically interfaced. The circuit board (905) is mounted to an inside wall of the upper housing (845).

Power received from an outside source e.g. a 120 volt Alternating Current (AC) power source is input to a power module (910) over an on/off switch (915), shown as (30) in FIG. 1. The power module (910) includes an AC to DC voltage converter for converting input power to one or more DC voltages and a switch controller collectively (945). Each DC voltage is distributed to various DC devices (920) over one or more power buses and/or over individual wire connections (925) and (930). DC power devices (920) include the solenoid (720), the water heaters (312) and (314), the indicator light or lights (32) and the rotary drive motor (248). In addition to the AC to DC voltage converter the power module (910) may include additional DC to DC voltage converters operable to provide different DC voltages e.g. 5 volts, 12 volts and 24 volts as may be required by individual DC power devices (920). Thus for example the DC devices connected on bus (930) may comprise 12 volt devices and the DC device connected on bus (925) may comprise 24 volt devices and the logic element (935) may comprise a 5 volt device. The voltage converter, switch controller (945) is in communication with a logic element (935) which sends commands to the switch controller (945) to connect power to and disconnect power from each of the DC power devices (920). In addition the DC voltage converter powers the logic element (935) and other electronic elements connected to the logic element.

A fixed logic or programmable logic device controller (935) is provided on the circuit board (905). The logic device is in communication with a switch controller (945) associated with the power module (910), with one or more analog sensors such as the temperature sensors (322) and (324), described above, and with a memory module (950). The memory module and switching controller (945) may be incorporated within the controller (935). The controller (935) comprises a digital processor operating a control program and or logical control elements designed to operate the coffee grind and brew system of the present invention. The program may retrieve digital data from the memory module for certain operations such as to look up analog sensor voltage to water temperature calibration data in a look up table or the like. Additionally, the logic control element includes a clock or counter suitable for tracking elapsed time and sequencing operations according to predefined temporal parameters.

In various embodiments the controller (935) may comprise a micro-processor alone, a micro-controller which includes a micro-processor plus embedded Read Only Memory (ROM), Random Access Memory (RAM) and other embedded features e.g. a switch controller, a commutations interface, or the like. In simpler embodiments the controller (935) may comprise a programmable logic device (PDL) comprising reconfigurable digital circuits which is specifically programmed to operate the grind and brew coffee system of the present invention.

In basic form the control program starts when the coffee maker is turned on by a user and manages the operation of each electro-mechanical component of the coffee brewing system of the present invention. To operate various electrical components such as to turn the rotary motor (248) on and off the controller (935) according to the control program communicates with the switch controller (945) which actuates a switch to connect the power channel (925) to a power input of the appropriate voltage to operate the motor. Similarly to actuate the solenoid (720), to open the port valve module (705), the controller (935), according to the control program, communicates with the switch controller (945) which actuates a switch to connect the solenoid (702) to a power input of the appropriate voltage to actuate the solenoid to dispense coffee.

Optionally other sensors and/or user interface devices (955) may be provided in communication with the controller (935). Other sensors may include water present or water level sensors in the water receptacle, coffee beans present or coffee bean hopper fill level, cup present sensor or sensors for determining if a cup is present in the dispensing position and/or filter assembly present and/or filter clean sensors for determining if a clean filter is present. Optionally additional user interface elements can also add functionality such as a graphic display device and associated input device(s) such as a single key, key pad, one or more toggle switches or switch positions or touch screen input associated with the display device. Additionally other AC or DC power devices (960) may be included such as a separate motor for driving the agitator module (600) or a separate motor for driving the bean grinding module (202).

### 3.1.8 Example Operating Mode

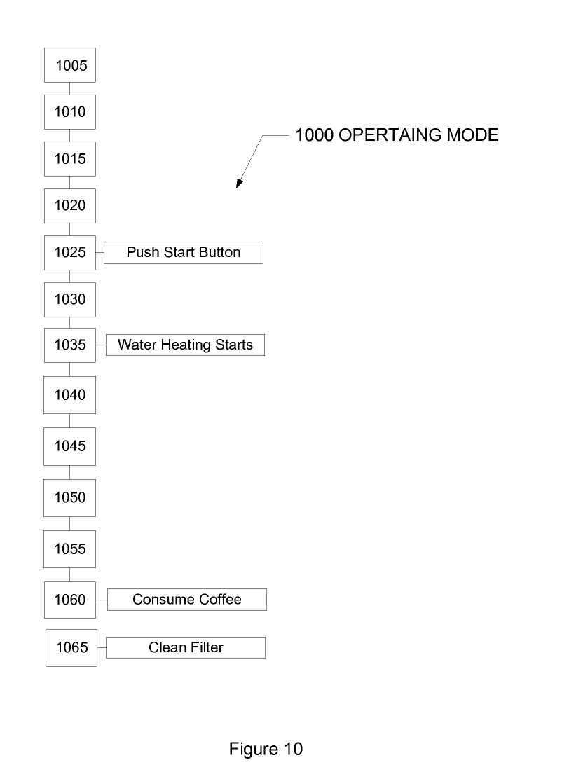

Referring now to FIGS. 1-3 and 10, a non-limiting exemplary operating mode of the present invention is shown in a flow diagram (1000). In step (1005) a single coffee cup e.g. (22) is placed centered under a front protruding edge of the brewing module (204). If two cups are brewed simultaneously, each cup is positioned under a front protruding edge of the brewing module (204) such that coffee dispensed from the dispensing port (318) is dispensed into cup (22) and coffee dispensed from the dispensing port (320) is dispensed into cup (24). In a preferred embodiment, each coffee serving is about 12 fluid ounces or about 0.36 liters. As described above, the default position of the port valve module (705) is the closed position shown in FIG. 7C such that any water poured into the water receptacle remains in the water receptacle until the port valve module is opened by the actuator module (700).

In step (1010) whole coffee beans are poured into the hopper (28). The volume or weight of the whole coffee beans may be premeasured, e.g. ⅓ cup of whole coffee beans per coffee serving or about 11 grams of whole beans per serving or the user may decide the volume of whole beans according to taste and brewing experiences. In some embodiments the hopper (26) can include one or two levels marked on the inside of the hopper e.g. for 1, 2 or more servings.

In step (1015) the user installs a cleaned filter assembly (500) into the water receptacle (300) through the aperture (26) using the filter handle (522).

In step (1020) fresh unheated water is poured into the water receptacle (300) through the aperture (26). The water receptacle is filled to the first fill level indicator (308) for single cup brewing or the water receptacle is filled to the second fill level indicator (310) for two cup brewing.

In step (1025) the user pushes the start button (30) to initiate a brewing cycle. Alternately other user interface elements e.g. menu based may be selected by the user to initiate a brewing cycle. In step (1030) the electronic controller causes the indicator light (32) to display a busy state. If for some reason the electronic controller detects an error condition, the brewing cycle may be terminated and the electronic controller causes the indicator light (32) to display an error state.

In step (1030) both heating elements (312) and (314) are provided with electrical current to begin heating water. Note that both heating elements are powered even during a single cup brewing cycle.

In step (1035) the electronic controller (935) begins monitoring temperature sensing signals from each of the temperature sensors (322) and (324) and starts a clock counting an on-time of the heating and waits for the water to reach a brewing temperature of 91 to 96° C. or 195-205° F. The electronic controller (935) also compares the heating element on-time with the expected heating profile data stored in memory. More generally the memory stores calibration data based on an actual heating cycle wherein temperature vs time and thermal sensor electrical signal response are matched to actual water temperature or temperature local to the thermal sensor if no water is present. The expected heating profile may also be expanded to include a range of acceptable temperature values for a given heater on time wherein the expanded range takes into account device to device tolerances and other relevant factors. The logic element operates to convert thermal sensor signals to actual water temperature values, based on the expected heating profile data stored in memory and uses active feedback to control each of the first and second heating elements as required to heat the water in the water receptacle to the brewing temperature range and thereafter to toggle the heating elements on and off to maintain the water temperature within the brewing range during the entire brewing cycle or at least during 90% of the brewing cycle duration.

If both temperature sensors indicate that the temperature increase vs heater on-time is within the expected heating profile parameters no action is taken. However if one or both temperatures sensors (322) or (324) indicate rapid heating that is outside the rate of temperature increase predicted by the expected heating profile the electronic controller (935) commands the switching controller (945) to discontinue power distribution to one or both heater elements (312) or (314). In one common condition wherein a one cup serving is being brewed, and there is no water in the upper part of the water receptacle, the electronic controller (935) depowers the upper heater (314) after it detects that the temperature reported by the upper temperature sensor (322) is rising more quickly than the expected. In another example case when a user forgets to add any water to the water receptacle the electronic controller (935) depowers both heating elements (312) and (314) after it detects that the temperature reported by both temperature sensors (322), (324) is rising more quickly than the expected

Once the brewing temperature range is reported by one or both temperature sensors and the heater element on-time to reach the brewing temperature is within expected limits the water temperature is maintained within the brewing temperature range by depowering the heating element(s) when the maximum of the brewing temperature range is exceeded and repowering the heating element(s) when the measured temperature falls below the minimum of the brewing temperature range.

In step (1040) the electronic controller (935) commands the switch controller (945) to power the rotary motor (248) which starts both coffee bean grinding and water agitation by the agitator module (600). In addition the electronic controller (935) starts a brewing timer clock. As the bean grinder module (202) grinds whole coffee beans into coarse coffee grounds or particles, the coffee grounds exit the grinder module through the exit aperture (244) and fall into the water receptacle through the aperture (26) where they are kept in suspension by the mixing action provided by the agitator module (600). In one non-limiting example operating mode the rotary motor (248) continuously operates the bean grinding module (202) and the agitator module (600) during the entire brewing time or cycle, which ends when the brewing time clock reaches a predetermined brewing time. In other operating modes, the rotary motor (248) continuously operates the bean grinding module (202) and the agitator module (600) for a portion of the brewing time such as for a predetermined bean grinding duration that is long enough to grind all the coffee beans in the hopper. After the bean grinding duration, the electronic controller may operate the rotary motor (248) intermittently for the remainder of the brewing time to periodically agitate the water and coffee grounds during the remaining brewing time. Additionally in some non-limiting operating mode examples the brewing time may be varied according to user inputs.

In a preferred operating mode the brewing time is fixed at three minutes. The three minute brewing time is based on several factors including grind coarseness of the grinder module, which is not adjustable, and the ratio of the coffee bean hopper size or fill levels to water receptacle fill levels. In addition the brewing time is in part determined empirically based on coffee solids to water ratios and coffee tasting.

In step (1045) at the end of the brewing time the electronic controller (935) commands the switching module (945) to terminate power delivery to the heating elements (312) and (314) and to deliver power to the solenoid (720) which operates to open the port valve assembly (705). This causes brewed coffee to be dispensed through both the dispensing ports (318) and (320) into either one or two cups. Meanwhile the filter assembly (500) filters coffee grounds from the brewed coffee and traps the coffee grounds in the filter basket.

In step (1050) the electronic controller (935) starts a dispensing clock and holds the port valve module open for a predetermined dispensing period tracked by the dispensing clock.

In step (1055) the electronic controller (935) commands the switching module (945) to depower the solenoid (720) which closes the port valve assembly (705) while also changing the status of the indicator light to indicate that the brewing cycle is completed.

In step (1060) the user removes the brewed coffee for consumption.

In step (1065) the user removes the filter assembly (500) in order to remove the used coffee grounds therefrom and rinse the mesh filter portions for reuse.

It will also be recognized by those skilled in the art that, while the invention has been described above in terms of preferred embodiments, it is not limited thereto. Various features and aspects of the above described invention may be used individually or jointly. Further, although the invention has been described in the context of its implementation in a particular environment, and for particular applications (e.g. brewing coffee), those skilled in the art will recognize that its usefulness is not limited thereto and that the present invention can be beneficially utilized in any number of environments and implementations where it is desirable to extract or dissolve solid material in a liquid at elevated temperature. Accordingly, the claims set forth below should be construed in view of the full breadth and spirit of the invention as disclosed herein.

1. A coffee brewing device comprising:
a water receptacle having a liquid volume capacity of at least two coffee servings;
two independently operable electrical heating elements attached to surfaces of the water receptacle;
wherein a first electrical heating element is disposed proximate to a first portion of the water receptacle associated with heating water for a single coffee serving;
wherein a second electrical heating element is disposed proximate to a second portion of the water receptacle associated with heating water for more than a single coffee serving.

2. The coffee brewing device of claim 1 wherein the water receptacle comprises a cylindrical wall and a disk shaped base wall attached to the cylindrical wall at a lower rim thereof wherein the cylindrical wall forms a top circular aperture at an upper rim thereof.

3. The coffee brewing device of claim 2 wherein the cylindrical wall and the disk shaped base wall are integrally formed from a unitary metal blank comprising stainless steel.

4. The coffee brewing device of claim 3 wherein the cylindrical wall and the disk shaped base wall have a thickness ranging from 0.5 to 3.0 mm.

5. The coffee brewing device of claim 2 wherein the first electrical heating element is attached to a lower portion of an outside surface of the cylindrical wall substantially between the disk shaped base wall and a fill level associated with the single coffee serving.

6. The coffee brewing device of claim 5 wherein the second electrical heating element is attached to an upper portion of the outside surface of the cylindrical wall substantially between the fill level associated with the single coffee serving and the upper rim.

7. The coffee brewing device of claim 6 wherein each of the first and second electrical heating elements comprises a heating element module formed by a plurality of resistive heating elements disposed on a backing material wherein the backing material has a thermal conductivity of at least 3.0 W/m ° K and an electrical resistivity of greater than 10¹¹ ohms per square and the plurality of electrical heating elements are connected in parallel between electrical terminals.

8. The coffee brewing device of claim 1 further comprising an electronic controller comprising:
a power module configured to deliver a power signal to each of the first electrical heating element and the second electrical heating element;
a first switching element operable to connect the first electrical heating element to and disconnect the first electrical heating element from the power module;
a second switching element operable to connect the second electrical heating element to and disconnect the second electrical heating element from the power module;
a logic element and an associated memory module, operating a control program, in electrical communication with each of the first and second switching elements for selectively operating each of the first and the second switching elements in accordance with one or more operating modes of the control program; and,
a user interface element operable by a user to initiate a coffee brewing cycle.

9. The coffee brewing device of claim 8 further comprising:
a first thermal sensor in communication with the logic element disposed to respond to a variation in thermal energy proximate to the first electrical heating element;
a second thermal sensor in communication with the logic element disposed to respond to a variation in thermal energy proximate to the second heating element;
wherein the electronic controller operates to monitor a thermal sensor electrical signal from each of the first and second thermal sensors and to covert the thermal sensor electrical signals to a substantially actual temperature value of water inside the water receptacle.

10. The coffee brewing device of 9 wherein each of the thermal sensors comprises a thermistor.

11. The coffee module of claim 9 wherein upon receiving a thermal sensor electrical signal having an actual temperature value within a brewing temperature range of 91 to 96° C., the logic element further operates the first and second electrical heating elements to maintain the actual temperature values read from the thermal sensors within the brewing temperature range of 91 to 96° C. for at least 90% of a brew time.

12. The coffee module of claim 9 wherein the memory module stores digital data including an expected heating profile and the logic element operates to compare the thermal sensor electrical signal values from each of the first and second thermal sensors with the expected heating profile and to disconnect one or both of the first and second heating elements from the power module whenever one of the thermal sensor signal values deviates from expected heating profile.

13. A coffee brewing method comprising the steps of:
heating water in a water receptacle to a brewing temperature in a range of 91 to 96° C. using a first heating element;
dispensing coffee grounds into the water receptacle after the water in a water receptacle reaches the brewing temperature range;
maintaining full contact between the water in the water receptacle and the coffee grounds for a desired brewing time;
maintaining the temperature of the water in the water receptacle within the brewing temperature range for at least 90% of the desired brewing time;
opening a port valve element at a base of the water receptacle after the desired brewing time is completed to dispense brewed coffee from the water receptacle.

14. The method of claim 13 further comprising the step of generating fluid turbulence in the water in the water receptacle for at least a portion of the desired brewing time.

15. The method of claim 13 further comprising the step of generating fluid turbulence in the water in the water receptacle for the entire duration of the desired brewing time.

16. The method of claim 13 wherein the water receptacle includes a coffee filter assembly including a filter element installed therein wherein the filter elements is positioned such that water being dispensed through the valve at the base of the water receptacle passes through the filter element, further comprising the step of filtering coffee grounds from brewed coffee being dispensed from the water receptacle.

17. A coffee brewing device comprising:
a water receptacle having a liquid volume capacity and a dispensing port passing through a base wall thereof;
a first electrical heating element disposed to heat water inside water receptacle;
a first thermal sensor disposed to generate a thermal sensor signal responsive to changes in temperature proximate to the first heating element;
an electronic controller comprising a logic element, a memory associated with the logic element, control logic elements operating on the logic element, and a power and switching module in communication with the logic element;
wherein the logic element is in communication with the thermal sensor and is operable to control the first heating element to heat the water inside the water receptacle to a brewing temperature with an actual water temperature range of 91 to 96° C. and to maintain the actual temperature of the water inside the water receptacle within the brewing temperature range for at least 90% of a desired brewing time.

18. The coffee brewing device of claim 17 further comprising a bean grinding module comprising:
a hopper for receiving whole coffee beans therein;
a fixed serrated grinding element and a rotatable serrated grinding element operable to grind coffee beans to coffee grounds when the rotatable serrated grinding element is rotated;
a first rotary drive motor coupled to the rotatable serrated grinding element for rotating the rotatable serrated grinding element at less than 600 revolutions per minute (RPM);
wherein the hopper and the grinding element pair are disposed above the water receptacle such that the coffee grounds exiting from the bean grinding module are gravity fed into the water receptacle during grinding;
wherein the first rotary drive motor is operable by the logic element and the power and switching module to one of rotate and not rotate the rotatable serrated grinding element.

19. The coffee brewing device of claim 17 further comprising a
a port valve module comprising a port valve element disposed to seal the dispensing port and a spring for applying a biasing force to bias the port valve element to a closed position;
an electrical valve actuator coupled to the port valve element by a linkage wherein movement of the electrical valve actuator overcomes the biasing force to move the port valve element to an open position;
wherein the electrical valve actuator is operable by the logic element and the power and switching module to one of, close the dispensing port when no power is applied to the electrical valve actuator, and open the dispensing port to dispense coffee therefrom when power is applied to the electrical valve actuator.

20. The coffee brewing device of claim 17 further comprising a rotatable agitator blade coupled to a second rotary motor for rotation thereby wherein the second rotary drive motor is operable by the logic element and the power and switching module to one of rotate and not rotate the agitator blade.

21. The coffee brewing device of claim 20 wherein the first rotary motor and the second rotary motor are the same rotary motor and rotation of the rotary motor simultaneously rotates the rotatable serrated grinding element and the agitator blade.

22. The coffee brewing device of claim 17 further comprising a coffee filter assembly including a filter element installed inside the water receptacle wherein the filter element is disposed to filter the coffee grounds from the brewed coffee inside the water receptacle as the brewed coffee is dispensed through the dispensing.

23. The coffee brewing device of claim 17 further comprising one or more user interface elements in communication with the logic element wherein each user interface elements is one of operable by and interpretable by a user to at least initiate a coffee brewing cycle and indicate when the coffee brewing cycle is complete.

24. The coffee brewing device of claim 17 further comprising:
a second electrical heating element disposed to heat water inside water receptacle;
a second thermal sensor disposed to generate a thermal sensor signal responsive to changes in temperature proximate to the second heating element;
wherein the logic element is in communication with the first and the second thermal sensors and is operable to control each of the first and the second heating elements to heat the water inside the water receptacle to a brewing temperature with an actual water temperature in a range of 91 to 96° C. and to maintain the actual temperature of the water inside the water receptacle within the brewing temperature range for at least 90% of a brewing cycle duration;
wherein both the first and the second electrical heating elements are continuously operated to heat water inside the water receptacle;
wherein the memory module stores digital data including an expected heating profile and the logic element operates to compare thermal sensor signals from each of the first and second thermal sensors with the expected heating profile and to disconnect any heating element from the power module when the associated thermal sensor signal deviates from an expected sensor signal range indicated by the expected heating profile.

25. The coffee brewing device of claim 17 and the wherein the dispensing port comprises two dispensing ports each passing through the base wall of the water receptacle and the port valve element simultaneously seals both of the two dispensing ports such that when the electrical valve actuator overcomes the biasing force to move the port valve element to an open position coffee is dispensed from both of the two dispensing ports.
